(19) United States
(12) Patent Application Publication
(10) Pub. No.: US 2011/0303202 A1
(43) Pub. Date: Dec. 15, 2011

(54) INTERNAL COMBUSTION ENGINE

(75) Inventors: Stefan Moser, Ludwigsburg (DE); Thomas Krämer, Stuttgart (DE); Wolfgang Zücker, Ditzingen (DE); Thomas Laudenbach, Pleidelsheim (DE)

(73) Assignee: Dr. Ing. h.c.F. Porsche Aktiengesellschaft, Stuttgart (DE)

(21) Appl. No.: 13/151,552

(22) Filed: Jun. 2, 2011

(30) Foreign Application Priority Data
Jun. 11, 2010 (DE) 102010024005.2
Jun. 11, 2010 (DE) DE 102010024004.4

(51) Int. Cl. F02B 75/02

(52) U.S. Cl. 123/65 R

(57) ABSTRACT

An internal combustion engine, having at least one cylinder bank, the or each cylinder bank having two outer high pressure cylinders and a central low pressure cylinder, reciprocating pistons of the cylinders being coupled via connecting rods to a crankshaft, the valves of the cylinders being actuated via camshafts which can be driven from the crankshaft, crossflow channels for exhaust gas formed in the region of the or each cylinder bank between outlet valves of the high pressure cylinders and inlet valves of the respective low pressure cylinder, and each crossflow channel and the respective high pressure cylinder of the or each cylinder bank being designed in such a way that a dimensional ratio of a volume of the crossflow channel in cm³ to the product of a swept volume of the respective high pressure cylinder in cm³ and a charging pressure in bar is between 0.05 and 0.5.

The invention relates to an internal combustion engine according to the preamble of claim 1 and 5.

EP 1 961 943 A1 has disclosed an internal combustion engine having a plurality of cylinder banks, each cylinder bank having two outer high pressure cylinders which operate with fuel supply in the four stroke process and a central low pressure cylinder which operates without dedicated fuel supply in the two stroke process and is filled or loaded with exhaust gas from the two outer high pressure cylinders of the respective cylinder bank. Valves, namely inlet valves and outlet valves, of the cylinders of the cylinder banks of the internal combustion engine which is disclosed in this prior art can be actuated via camshafts. Reciprocating pistons of the cylinders of the cylinder banks are coupled to crankpin journals of a crankshaft. The camshafts of the cylinder banks can be driven from the crankshaft.

US 2009/0223482 A1 has disclosed a further internal combustion engine having two cylinder banks, of which each cylinder bank has in each case two outer high pressure cylinders which operate with fuel supply in the four stroke process and a central low pressure cylinder which operates without dedicated fuel supply in the two stroke process. In this prior art, reciprocating pistons of the cylinders of the cylinder banks are also coupled via connecting rods to a crankshaft, crankpin journals of this type of the crankshaft, on which crankpin journals the connecting rods of the high pressure cylinders act, lying in a common plane, whereas crankpin journals of this type of the crankshaft, on which crankpin journals the connecting rods of the low pressure cylinders act, are offset with respect to said plane as viewed in the rotational direction or circumferential direction of the crankshaft, namely by 90°. Reciprocating pistons of those cylinders of the different cylinder banks which lie opposite one another in the rotational direction of the crankshaft or in the circumferential direction of the crankshaft act via their respective connecting rods on common crankpin journals of the crankshaft. Thus, according to this prior art, the crankpin journals of the crankshaft, on which the reciprocating pistons of high pressure cylinders which lie opposite one another act jointly via their connecting rods, lie in a common plane, the crankpin journal of the crankshaft, on which the reciprocating pistons of those low pressure cylinders of the two cylinder banks which lie opposite one another in the circumferential direction of the crankshaft act jointly via their connecting rods, being offset with respect to said plane by 90°.

DE 31 21 301 A1 has disclosed a further internal combustion engine which has two cylinder banks with in each case three cylinders, namely with in each case two outer high pressure cylinders which operate with fuel supply in the four stroke process and a central low pressure cylinder which operates without dedicated fuel supply in the two stroke process, the low pressure cylinder of the respective cylinder bank being filled alternately with exhaust gas from the two outer high pressure cylinders of the respective cylinder bank. It is already known from this prior art to arrange the two cylinder banks with respect to one another in the form of an inline engine or in the form of a V engine or in the form of a boxer engine.

Although it is already known from the prior art cited above to use the exhaust gas of the high pressure cylinders which operate with fuel supply in the four stroke process in the low pressure cylinders of the cylinder banks in order to increase the degree of efficiency of an internal combustion engine, there is a requirement for a further increase in the degree of efficiency of internal combustion engines of this type using simple means.

Proceeding from this, the present invention is based on the object of providing a novel internal combustion engine. This object is achieved according to a first aspect of the invention by an internal combustion engine as claimed in claim 1. According to this, the or each crossflow channel and the respective high pressure cylinder of the or each cylinder bank are designed in such a way that a dimensional ratio between a volume of the crossflow channel in cubic centimeters and the product of a swept volume of the respective high pressure cylinder in cubic centimeters and a charging pressure for the latter in bar is between 0.05 and 0.5.

According to a second aspect of the invention, this object is achieved by an internal combustion engine as claimed in claim 5. According to this, each low pressure cylinder of the or each cylinder bank is designed in such a way that a dimensionless compression ratio between the sum of a swept volume and a compression volume of the low pressure cylinder and the compression volume of the low pressure cylinder is between 20 and 35.

The degree of efficiency can be increased using simple means by way of the two aspects of the invention which can be used in an internal combustion engine either on their own or in combination with one another.

Preferred developments of the invention result from the subclaims and the following description. Without being restricted thereto, exemplary embodiments of the invention will be explained in greater detail using the drawing, in which:

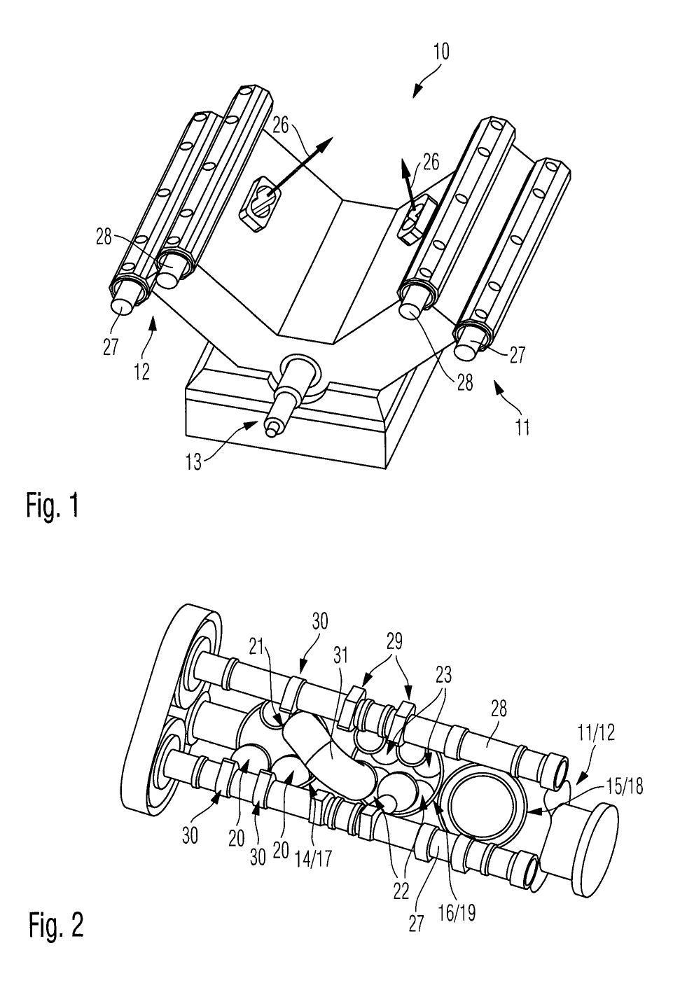

FIG. 1 shows a perspective view of a detail of one exemplary embodiment of an internal combustion engine according to the invention with two cylinder banks,

FIG. 2 shows a perspective view of a detail of the internal combustion engine from FIG. 1 in the region of a cylinder bank and camshafts which are assigned to said cylinder bank,

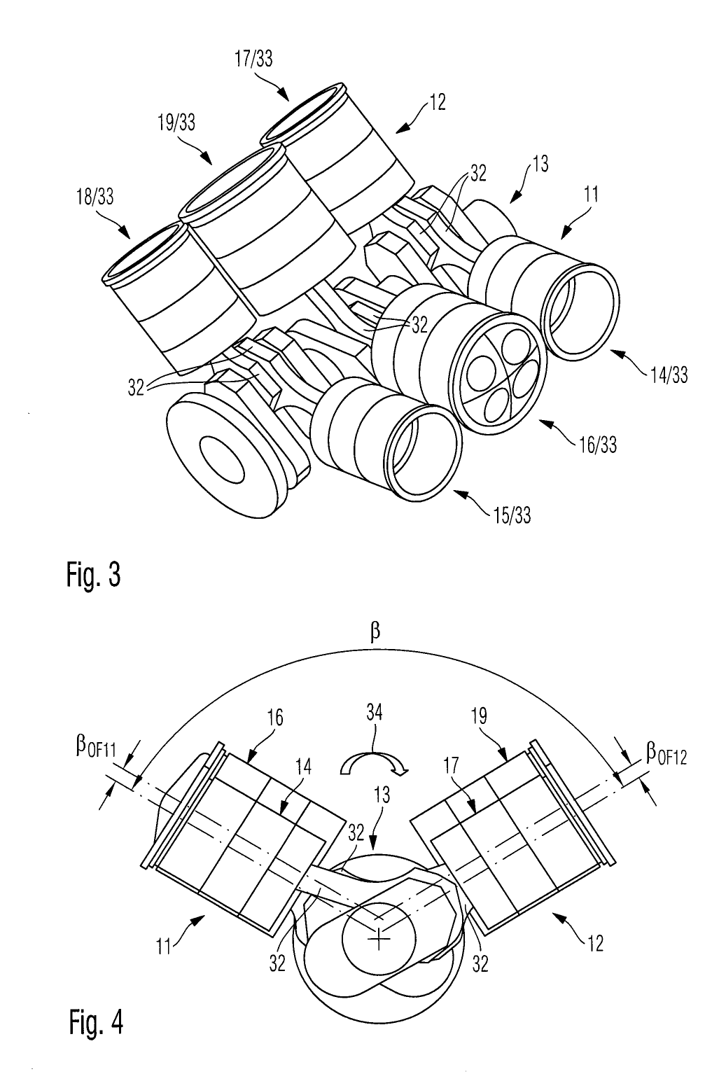

FIG. 3 shows a perspective view of a further detail of the internal combustion engine from FIG. 1 in the region of a crankshaft and cylinders which are coupled to the crankshaft via connecting rods,

FIG. 4 shows the detail of FIG. 4 in a front view,

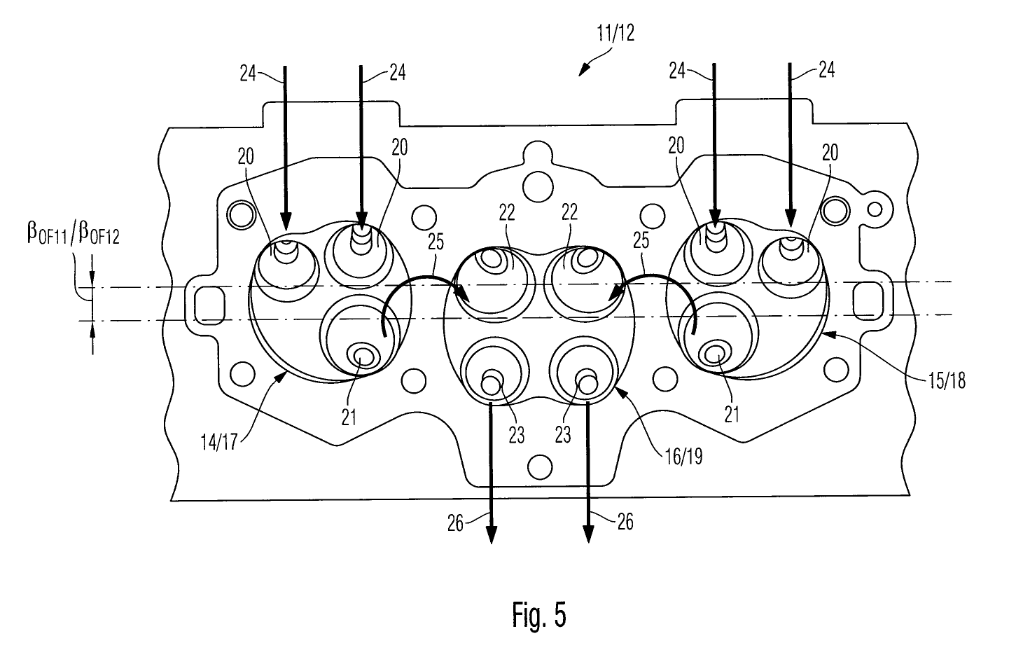

FIG. 5 shows a view of valves of a cylinder bank of the internal combustion engine from FIG. 1,

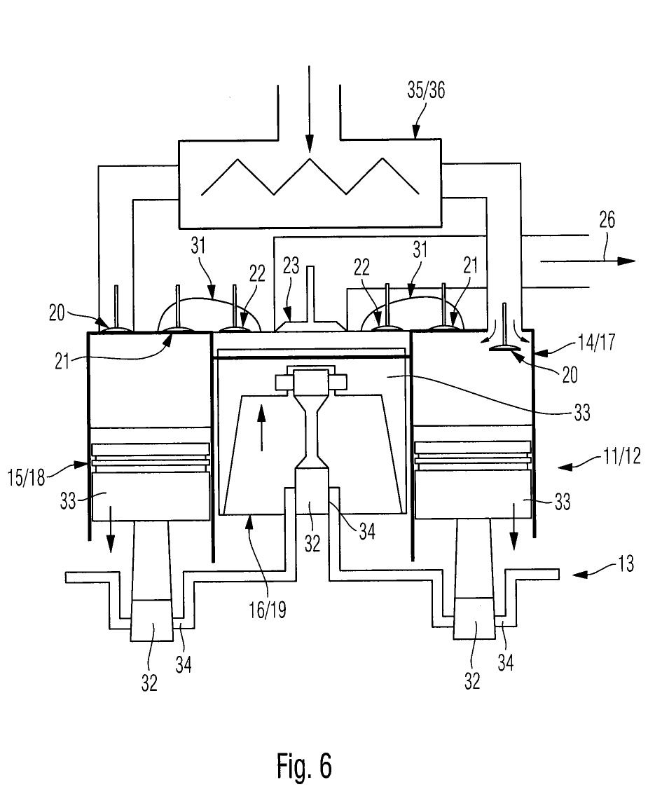

FIG. 6 shows a detail of the internal combustion engine from FIG. 1 in the region of a cylinder bank and valves assigned to this cylinder bank, and

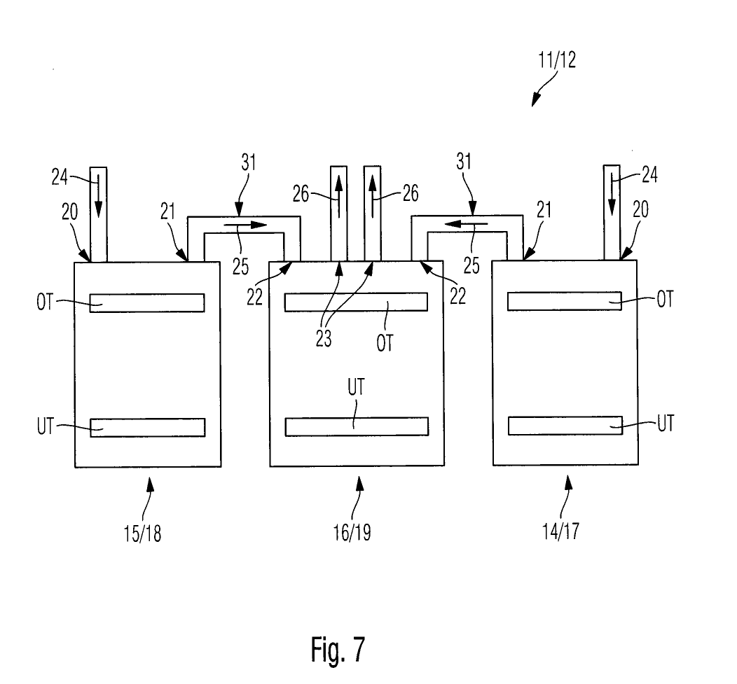

FIG. 7 shows a schematic representation of FIG. 6.

The present invention relates to an internal combustion engine of a motor vehicle. FIG. 1 shows a perspective view of one exemplary embodiment of an internal combustion engine 10 according to the invention which has two cylinder banks 11 and 12 which are arranged in a V position with respect to one another, each of the cylinder banks 11 and 12 comprising in each case three cylinders. FIG. 3 diagrammatically shows the cylinders of the two cylinder banks 11 and 12 together with a crankshaft 13. A first cylinder bank 11 comprises two outer high pressure cylinders 14 and 15 which operate with fuel supply in the four stroke process and a central low pressure cylinder 16 which operates without dedicated fuel supply in the two stroke process and is filled alternately with exhaust gas from the high pressure cylinders 14, 15. The second cylinder bank 12 likewise comprises two outer high pressure cylinders 17 and 18 which operate with fuel supply in the four stroke process and a central low pressure cylinder 19 which operates without dedicated fuel supply in the two stroke process and is filled alternately with exhaust gas from the high pressure cylinders 17 and 18.

As can be gathered best from FIG. 3, the cylinders of the first cylinder bank 11 and the cylinders of the second cylinder bank 12 are positioned in each case in line with respect to one another, the cylinders 14, 15 and 16 of the first cylinder bank 11 lying opposite the cylinders 17, 18 and 19 of the second cylinder bank 12 in the rotational direction of the crankshaft 13 or in the circumferential direction of the latter. The cylinders of the cylinder banks 11 and 12 lie opposite one another in such a way that firstly high pressure cylinders 14, 17 and 15, 18 and secondly low pressure cylinders 16, 19 lie opposite one another. It can thus be gathered from FIGS. 3, 4 that the high pressure cylinders 14 and 17, the high pressure cylinders 15 and 18, and the low pressure cylinders 16 and 19 of the two cylinder banks 11 and 12 lie opposite one another in the rotational direction 34 of the crankshaft 13 or in the circumferential direction of the latter.

The cylinders of the two cylinder banks 11 and 12 are assigned valves. FIG. 5 shows a view of the valves of a cylinder bank 11 or 12 of the internal combustion engine according to the invention in the region of all the cylinders of the respective cylinder bank 11 or 12; according to FIG. 5, the two outer high pressure cylinders 14, 15 or 17, 18 which operate with fuel supply in the four stroke process comprise in each case two inlet valves 20 for fuel and combustion air or a fuel/combustion air mixture and in each case one outlet valve 21 for exhaust gas. When the high pressure cylinders operate with direct fuel injection, there are separate injection valves for fuel or combustible. The central low pressure cylinder 16 or 19 of the respective cylinder bank 11 or 12, which central low pressure cylinder 16 or 19 operates without dedicated fuel supply in the two stroke process, comprises two inlet valves 22 for exhaust gas and two outlet valves 23 for exhaust gas. As has already been mentioned, the low pressure cylinder 16 or 19 of each cylinder bank 11 or 12 is filled alternately with exhaust gas from the high pressure cylinders 14, 15 or 17, 18 of the respective cylinder bank 11, 12.

FIG. 5 uses arrows 24 to show the feed of the fuel/combustion air mixture to the respective outer high pressure cylinders of the cylinder banks. Arrows 25 visualize the crossflow of exhaust gas out of the outer high pressure cylinders 14, 15 or 17, 18 of the respective cylinder bank 11 or 12 into the respective low pressure cylinder 16 or 19 of said cylinder bank 11 or 12. Arrows 26 show the discharge of exhaust gas out of the respective low pressure cylinder 16, 19 of the respective cylinder bank 11, 12, it being possible for the exhaust gas to be fed either directly to an exhaust gas purification system or preferably to an exhaust gas turbocharger for a further increase in the degree of efficiency.

The abovementioned valves 20, 21, 22 and 23 of the cylinders of the cylinder banks 11 and 12 can be actuated via camshafts 27 and 28, namely via what are known as inlet camshafts 27 and what are known as outlet camshafts 28. Here, the inlet valves 20 of the high pressure cylinders 14, 15 or 17, 18 and the inlet valves 22 of the low pressure cylinders 16 or 19 are actuated via the respective inlet camshaft 27 of the respective cylinder bank 11 or 12, whereas the outlet valves 21 of the high pressure cylinders 14, 15 or 17, 19 and the outlet valves 23 of the low pressure cylinder 16 or 19 of the respective cylinder bank 11 or 12 are actuated by the respective outlet camshaft 28 of the respective cylinder bank 11 or 12.

As has already been described, the high pressure cylinders 14, 15 and 17, 18 of the two cylinder banks 11 and 12 operate in the four stroke process, whereas the low pressure cylinders 16 and 19 of the cylinder banks 11, 12 operate in the two stroke process. Here, the low pressure cylinders 16 and 19 are filled alternately with exhaust gas from the respective high pressure cylinders 14, 15 or 17, 18, as a result of which a different temporal actuation is required for the outlet valves 23 of the low pressure cylinders 16, 9 of the cylinder banks 11, 12 than for the remaining valves of the cylinders of the cylinder banks. Therefore, according to FIG. 2, cams which are configured as double cams 29 are positioned on the outlet camshaft 28 of the respective cylinder bank 11 or 12 for actuating the outlet valves 23 of the low pressure cylinder 16 or 19 of the respective cylinder bank 11 or 12, whereas the cams for actuating the remaining valves 20, 21 and 22 of the cylinders of the respective cylinder bank 11 or 12 are configured as single cams 30.

In order to ensure the crossflow of the exhaust gas from the high pressure cylinders 14, 15 or 17, 18 of the cylinder banks 11, 12 into the low pressure cylinder 16, 19 of the respective cylinder bank, there are crossflow channels, FIG. 2 showing a crossflow channel 31 of this type.

The internal combustion engine 10 has the crankshaft 13, it being possible for the camshafts 27, 28 of the cylinder banks 11, 12 to be driven via the crankshaft 13. Reciprocating pistons 33 of the cylinders 14 to 19 of the two cylinder banks 11 and 12 are coupled to the crankshaft 13 via connecting rods 32, the connecting rods 32 of the reciprocating pistons 33 acting on what are known as crankpin journals 34 of the crankshaft 13.

As has already been described, the cylinder banks 11 and 12 of the internal combustion engine 10 in the exemplary embodiment shown are positioned with respect to one another so as to ensure a V design, namely according to FIG. 4 in such a way that the high pressure cylinders 14 and 15 of the first cylinder bank 11 and the high pressure cylinders 17 and 18 of the second cylinder bank 12 enclose a defined cylinder bank offset angle β as viewed in the rotational direction 34 of the crankshaft 13. According to FIG. 4, said cylinder bank offset angle β is, for example, 120°. However, the defined cylinder bank offset angle β can also be 90° or 180°. Furthermore, other cylinder bank offset angles β are also conceivable.

Furthermore, as can be gathered from FIG. 4, the low pressure cylinder 16 of the first cylinder bank 11 is offset by a first defined cylinder skew offset angle β_{OF11} with respect to the high pressure cylinders 14 and 15 of said first cylinder bank 11. The low pressure cylinder 19 of the second cylinder bank 12 is offset by a second defined cylinder skew offset angle β_{OF12} with respect to the high pressure chambers 17, 18 of said second cylinder bank 12. Here, according to FIG. 4, said cylinder skew offset angles β_{OF11} and β_{OF12} are preferably of equally great magnitude, but they have different algebraic signs. However, it is also possible that the magnitudes of the two cylinder skew offset angles β_{OF11} and β_{OF12} also differ from one another. In FIG. 4, the low pressure cylinder 16 of the cylinder bank 11 is offset by the cylinder skew offset angle β_{OF11} with respect to the high pressure cylinders 14 and 15 of said cylinder bank 11 in the rotational direction 34 of the crankshaft 13, whereas the low pressure cylinder 19 of the cylinder bank 12 is offset by the cylinder skew offset angle β_{OF12} with respect to the high pressure cylinders 17, 18 of said cylinder bank 12 in the opposite direction to the rotational direction 34 of the crankshaft 13. The cylinder skew offset angles β_{OF11} and β_{OF12} have a magnitude between 1° and 10°.

As a result of the above offset of the low pressure cylinders 16 and 19 with respect to the high pressure cylinders 14, 15 and 17, 18 of the cylinder banks 11 and 12, crossflow channels 31 with relatively small volumes can be provided. A small volume in a crossflow channel 31 minimizes losses during the expansion of the exhaust gas which is to be transferred via the respective crossflow channel 31. This has positive effects on the degree of efficiency which can be achieved with the internal combustion engine.

The offset in opposite directions is advantageous, in particular, when the exhaust gases, starting from the low pressure cylinders 16, 19, are to be fed to an exhaust gas turbocharger in order to further increase the degree of efficiency which can be realized with the internal combustion engine.

As has already been described, the reciprocating pistons 33 of the cylinders 14 to 19 of the cylinder banks 11 and 12 act via their connecting rods 32 on the crankshaft 13, namely on crankpin journals 34 of the crankshaft 13. This can be gathered best from FIGS. 3 and 6.

Furthermore, as can be gathered from FIG. 6, compressed combustion air is fed via a compressor 35 at a defined charging pressure p_{L-H} to the high pressure cylinders 14, 17 and 15, 18. The charging pressure p_{L-H} is the difference between the pressure of the combustion air immediately downstream of the compressor 35, which pressure can be provided by an exhaust gas turbocharger or a compressor, and the ambient pressure. FIG. 6 shows a charge air cooler 36 of the compressor 35.

FIG. 7 shows that the reciprocating pistons 33 of all the cylinders of the cylinder banks 11, 12, that is to say of the high pressure cylinders 14, 15, 17 and 18 and of the low pressure cylinders 16, 19, are moved to and fro between a bottom dead center UT and a top dead center OT. The volume between the bottom dead center UT and the top dead center OT of the respective cylinder determines what is known as the swept volume of said cylinder. The volume above the top dead center OT of the respective cylinder determines what is known as the compression volume of the respective cylinder.

In order then to ensure effective operation with a high degree of efficiency of an internal combustion engine of this type, it is proposed according to a first aspect of the present invention that each crossflow channel 31 and the respective high pressure cylinder 14, 15, 17, 18 of each cylinder bank 11 and 12, which high pressure cylinder 14, 15, 17, 18 interacts with the crossflow channel 31, is designed in such a way that a dimensional ratio between a volume of the crossflow channel 31 in cm³ and the product of the swept volume of the respective high pressure cylinder 14, 15, 17 or 18 in cm³ and the charging volume for the latter in bar is between 0.05 and 0.5. Accordingly, it holds that:

$$0.05 \leq \frac{{V}_{k}}{{V}_{h - H} * {p}_{L - H}} \leq 0.5 ,$$

wherein V_{K} is the volume of the crossflow channel 31 in cm³, V_{h-H} is the swept volume of the respective high pressure cylinder in cm³ and p_{L-H} is the charging pressure of the respective high pressure cylinder in bar.

The above ratio is preferably between 0.05 and 0.25.

One variant of the invention is particularly preferred, in which said ratio is between 0.05 and 0.15 or between 0.05 and 0.125.

As has already been mentioned, the charging pressure is the difference between the pressure of the combustion air and the ambient pressure.

As an alternative to the above first aspect of the invention or else in combination with the first aspect of the invention, the degree of efficiency of an internal combustion engine of this type can be increased further by virtue of the fact that each low pressure cylinder 16 and 19 of each cylinder bank 11, 12 is designed in such a way that a dimensionless compression ratio between the sum of the swept volume and the compression volume of the respective low pressure cylinder 16 or 19 and the compression volume of the low pressure cylinder 16 or 19 is between 20 and 35. Accordingly, it holds that:

$$20 \leq \frac{{V}_{h - N} + {V}_{c - N}}{{V}_{c - N}} \leq 35 ,$$

wherein V_{h-N} is the swept volume of the respective low pressure cylinder and V_{c-N} is the compression volume of the respective low pressure cylinder.

This dimensionless compression ratio is preferably either between 20 and 25 or between 30 and 35.

The details according to the invention can also be used in an internal combustion engine having a single cylinder bank or more than two cylinder banks.

### LIST OF DESIGNATIONS

10 Internal combustion engine
11 Cylinder bank
12 Cylinder bank
13 Crankshaft
14 High pressure cylinder
15 High pressure cylinder
16 Low pressure cylinder
17 High pressure cylinder
18 High pressure cylinder
19 Low pressure cylinder
20 Inlet valve
21 Outlet valve
22 Inlet valve
23 Outlet valve
24 Fuel and combustion air feed supply
25 Exhaust gas crossflow
26 Exhaust gas discharge
27 Inlet camshaft
28 Outlet camshaft
29 Double cam
30 Single cam
31 Crossflow channel
32 Connecting rod
33 Reciprocating piston
34 Crankpin journal
35 Compressor
36 Charge air cooler

1.-8. (canceled)

9. An internal combustion engine comprising:
at least one cylinder bank, the or each cylinder bank having two outer high pressure cylinders which operate with fuel supply in a four stroke process and a central low pressure cylinder which operates without fuel supply in a two stroke process and is filled alternately with exhaust gas from the high pressure cylinders of the cylinder bank,
reciprocating pistons of the cylinders of the or each cylinder bank being coupled via connecting rods to crankpin journals of a crankshaft,
inlet valves and outlet valves of the cylinders of the or each cylinder bank that are configured to be actuated via camshafts which are configured to be driven from the crankshaft, and
crossflow channels for exhaust gas formed in a region of the or each cylinder bank between outlet valves of the high pressure cylinders and inlet valves of the respective low pressure cylinder,
wherein each crossflow channel and the respective high pressure cylinder of the or each cylinder bank are configured such that a dimensional ratio of a volume of the crossflow channel in cubic centimeters to a product of a swept volume of the respective high pressure cylinder in cubic centimeters and a charging pressure for the respective high pressure cylinder in bar is between 0.05 and 0.5.

10. The internal combustion engine as claimed in claim 9, wherein the dimensional ratio is between 0.05 and 0.25.

11. The internal combustion engine as claimed in claim 10, wherein the dimensional ratio is between 0.05 and 0.15.

12. The internal combustion engine as claimed in claim 10, wherein each low pressure cylinder of the or each cylinder bank is configured such that a dimensionless compression ratio of a sum of a swept volume and a compression volume of the low pressure cylinder to a compression volume of the low pressure cylinder is between 20 and 35.

13. An internal combustion engine comprising:
at least one cylinder bank, the or each cylinder bank having two outer high pressure cylinders which operate with fuel supply in a four stroke process and a central low pressure cylinder which operates without fuel supply in a two stroke process and is filled alternately with exhaust gas from the high pressure cylinders of the cylinder bank,
reciprocating pistons of the cylinders of the or each cylinder bank being coupled via connecting rods to crankpin journals of a crankshaft,
inlet valves and outlet valves of the cylinders of the or each cylinder bank that are configured to be actuated via camshafts which are configured to be driven from the crankshaft, and
crossflow channels for exhaust gas formed in a region of the or each cylinder bank between outlet valves of the high pressure cylinders and inlet valves of the respective low pressure cylinder,
wherein each low pressure cylinder of the or each cylinder bank is configured such that a dimensionless compression ratio of a sum of a swept volume and a compression volume of the low pressure cylinder to a compression volume of the low pressure cylinder is between 20 and 35.

14. The internal combustion engine as claimed in claim 13, wherein the dimensionless compression ratio is between 20 and 25.

15. The internal combustion engine as claimed in claim 13, wherein the dimensionless compression ratio is between 30 and 35.

16. The internal combustion engine as claimed in claim 13, wherein each crossflow channel and the respective high pressure cylinder of the or each cylinder bank are configured such that a dimensional ratio of a volume of the crossflow channel in cubic centimeters to a product of a swept volume of the respective high pressure cylinder in cubic centimeters and a charging pressure for the respective high pressure cylinder in bar is between 0.05 and 0.5.
